(19) United States
(12) Patent Application Publication
(10) Pub. No.: US 2013/0187760 A1
(43) Pub. Date: Jul. 25, 2013

(54) SYSTEM AND METHOD FOR IDENTIFYING ITEMS AND PERSONS INSIDE VEHICLES

(71) Applicant: RFID MEXICO, S.A. de C.V., San Pedro Garza Garcia (MX)

(72) Inventor: JOSE-ADALBERTO TERAN-MATUS, MONTERREY (MX)

(73) Assignee: RFID MEXICO, S.A. DE C.V., SAN PEDRO GARZA GARCIA (MX)

(21) Appl. No.: 13/729,176

(22) Filed: Dec. 28, 2012

Related U.S. Application Data
(60) Provisional application No. 61/580,962, filed on Dec. 28, 2011.

(51) Int. Cl. G06K 19/07

(52) U.S. Cl. CPC G06K 19/0723
USPC 340/10.1

(57) ABSTRACT

A system and method for identifying and tracking items and persons inside one or more vehicles and provide reports such as inventory reports, report of persons onboard each vehicle, report of items that should not be onboard each vehicle during specific time and date, report of persons that should not be onboard each vehicle during specific times and dates, reports about the location of each item/person inside each vehicle, reports about items/persons that are located in a place in which they are not authorized to be; report about the items/persons that have boarded the vehicle, in which time and dates, and the locations where they were inside each vehicle.

### BACKGROUND OF THE INVENTION

A. Field of the Invention

The present invention is related to is related to systems and methods for identifying and tracking items inside a predetermined area and more particularly to a system and method for identifying and tracking items and persons inside vehicles.

B. Background of the Invention

One of the most important check out procedures of a departing vehicle, such as an aircraft is verifying that all the items that shall be onboard the aircraft, are indeed onboard and verifying that items that shall not be onboard the aircraft, are not onboard. Also, in certain environments, such as in military aircrafts, it is also very important to keep track of the personnel boarding an aircraft and of the personnel that is missing from an aircraft, in a quick and practical way.

Furthermore, in some cases, it is very important to know the location of an item inside an aircraft, even during a flight, and even to constantly track the location of the object inside the aircraft.

U.S. Pat. No. 7,030,760 of Brown, discloses a radio frequency identification (RFID) system includes an antenna located so that when baggage is being loaded on a vehicle, the antenna is capable of detecting information transmitted from at least one identity RFID tag located on the vehicle as well as information transmitted from a baggage RFID tag located on an item being loaded on or unloaded from the vehicle (though not necessarily simultaneously). A computer system is configured to compare the information transmitted from the identity RFID tag with expected vehicle information for the item loaded on or unloaded from the vehicle. An alarm condition may be generated if the results of the comparison indicate that the item is loaded on a vehicle other than that which was expected. The computer system may also provide notification to passengers or others regarding successful loading of the item on the vehicle.

Brown's system is not capable of detecting the baggage or items that are already onboard an aircraft. Therefore, if there is one or items that were not registered by the system by the airport personnel when they were loaded to the aircraft, there would be no record that such items are onboard of the aircraft and they may be lost. Furthermore, with Brown's system, it is not possible to detect the location of an item

In view of the above needs, applicant developed a system and method for identifying and tracking items and persons inside vehicles.

Applicant's system comprises a plurality of RFID item identification tags attached to each item that need to be monitored inside the vehicle, a plurality of RFID person identification tag for each person that need to be monitored inside the vehicle, and one or more RFID interrogators associated with the vehicle, for interrogating the plurality of RFID items/persons identification tags.

With applicant system and method it is possible to check that that all the items/persons that shall be onboard the vehicle, are indeed onboard and verifying that items/persons that shall not be onboard the vehicle, are not onboard, at anytime, even during operation of the vehicle.

It also may be known the location areas of all these objects or persons in order to validate, if they are in the correct place, in the event that such objects or persons should go inside the aircraft, and by the contrary, it would be possible to report their location to be timely removed. These checking operations are very important in such critical moments before departing from a specific location, but also, thanks to this solution it can be recorded at any time, the history about the movement of an object, goods and people even during flight providing an important control for sending alarms or even, for example in case it is necessary to check if an item, tool, piece or person moved from an authorized location or left the aircraft at an inappropriate place or time.

### SUMMARY OF THE INVENTION

It is therefore a main object of the present invention to provide a system and method for identifying and tracking items and persons inside vehicles.

It is another main object of the present invention, to provide a system of the above referred natures, which comprises a plurality of RFID item identification tags attached to each item that need to be monitored inside the vehicle, a plurality of RFID person identification tag for each person that need to be monitored inside the vehicle, and one or more RFID interrogators associated with the vehicle, for interrogating the plurality of RFID items/persons identification tags.

It is also a main object of the present invention, to provide a system and method of the above referred nature, by which it is possible to known the location areas of all these objects or persons in order to validate, if they are in the correct place, in the event that such objects or persons should go inside the aircraft, and by the contrary, it would be possible to report their location to be timely removed.

It is another object of the present invention, to provide a system and method of the above referred nature, by which it solution it can be recorded at any time, the history about the movement of an object, goods and people even during flight providing an important control for sending alarms or even, for example in case it is necessary to check if an item, tool, piece or person moved from an authorized location or left the aircraft at an inappropriate place or time.

These and other objects and advantages of the system and method for identifying and tracking items and persons inside vehicles of the present invention will become apparent to those persons having an ordinary skill in the art, from the following detailed description of the embodiments of the invention.

### DETAILED DESCRIPTION OF THE INVENTION

The system and method for identifying and tracking items and persons inside vehicles of the present invention will be described making reference to a preferred embodiment thereof.

In a preferred embodiment, the system for identifying and tracking items and persons inside vehicles of the present invention is used in one or more aircrafts having a plurality of items and persons that need to be monitored, wherein the system for identifying and tracking items and persons inside vehicles of the present invention comprising:

one or more RFID item identification tags, each assigned to a respective item to be monitored inside the aircraft and containing information about an item;

one or more RFID person identification tags, each assigned to a respective person to be monitored inside the aircraft and containing information about a person;

one or more static RFID tag interrogators/scanners, each associated with the aircraft, for interrogating/scanning the one or more RFID item identification tags, and the one or more RFID person identification tags;

a computer associated with the aircraft connected to the one or more RFID tag interrogators/scanners, said computer having a database containing information such as: items that shall be onboard the aircraft during a specific time and date; persons that shall be onboard the aircraft during a specific time and date; authorized places inside the aircraft for the items that shall be onboard the aircraft; authorized places inside the aircraft for the persons that shall be onboard the aircraft; times and dates during which an item is authorized to be onboard the aircraft; times and dates during which a person is authorized to be onboard the aircraft; times and dates during which an item is authorized to be onboard the aircraft in specific places; times and dates during which a person is authorized to be onboard the aircraft in specific places;

an external computer connected to the computer associated with each aircraft, by means of wireless communication or any other suitable communication means, said external computer having a database containing information such as: items that shall be onboard the aircraft during a specific time and date; persons that shall be onboard the aircraft during a specific time and date; authorized places inside the aircraft for the items that shall be onboard the aircraft; authorized places inside the aircraft for the persons that shall be onboard the aircraft; times and dates during which an item is authorized to be onboard the aircraft; times and dates during which a person is authorized to be onboard the aircraft; times and dates during which an item is authorized to be onboard the aircraft in specific places; times and dates during which a person is authorized to be onboard the aircraft in specific places.

The system of the present invention may carry out operations such as:

### Inventory Take.

The computer associated with the aircraft, activates the one or more RFID tag interrogators/scanners in order to interrogate/scan each RFID item identification tags in order to generate a report about each item that is onboard the aircraft in an specific time and date. If there is detected an item that in accordance with the database information, is not authorized to be in the aircraft, an alarm is activated, indicating the item or items that are not authorized to be onboard the aircraft.

### Detecting Persons Inside the Aircraft.

The computer associated with the aircraft, activates the one or more RFID tag interrogators/scanners in order to interrogate/scan each RFID person identification tags in order to generate a report about each person that is onboard the aircraft in an specific time and date. If there is detected a person that in accordance with the database information, is not authorized to be in the aircraft, an alarm is activated, indicating the person or persons that are not authorized to be onboard the aircraft.

Verifying that the Items/Persons that shall be Onboard the Aircraft on a Specific Time and Date are Onboard the Aircraft.

The computer associated with the aircraft, activates the one or more RFID tag interrogators/scanners in order to interrogate/scan each RFID item/person identification tags and compares the lecture information with the database information about the items/persons that shall be in the aircraft. If the comparison operation detect that one item or person is missing, an alarm is activated. By the contrary, if it is detected an item/person that in accordance with the database information, shall not be onboard the aircraft is such specific time and date an alarm is activated indicating the item/person that shall not be onboard in that specific time and date.

Reporting about the Location of Each Item/Person Inside the Aircraft.

The computer associated with the aircraft, activates the one or more RFID tag interrogators/scanners in order to interrogate/scan each RFID item/person identification tags in order to detect its location by triangulation or any other know method and display a representation of the location of the objects/persons in a display. If there is one or more items/persons that in accordance with the database are located in a wrong place, an alarm is activated, indicating the items/persons that are incorrectly located and the wrong place in which are located.

The computer associated with the aircraft and the external computer may interchange information and keep historical records about the items/persons that have boarded the aircraft, in which time and dates, and the locations where they were inside the aircraft.

The RFID identification tags may be of various technologies including active, passive, active and semi or having different frequency spectra, to perform this control. On the other hand they may be embedded into the infrastructure of one or more aircraft, in order to identify and control important pieces of the aircraft, such as motor parts, mechanisms, etc.

Furthermore, they may exists one or more nodes to provide power to the RFID tags either integrated into the RFID reader or in separate modules distributed in the aircraft. This considering that RFID technology requires receiving energy and use that energy to transmit the information contained in the tag. This concept of reader (s) of embedded RFID (s) on the aircraft, provides flexibility, information, monitoring and control, as status information can be obtained at any time and location as the location and number of readers and nodes energy suppliers can be studied with sufficient time and effort so as to ensure correct reading and location of all objects, tools, parts and/or people in the areas to be controlled. This configuration makes this invention different from other inventions that need the information to be read by an external reader, or a portable reader which require the aircraft to pass through a specific location or between a person at a particular time to perform the reading which creates the problem of having the risk of not achieving full readings.

Should be more of an RFID reader (usually the number of RFID readers depend of size of the aircraft and of the areas that are desired to track) these can be placed in different locations of the aircraft so that it can determine the location of objects that are identified, additionally ensuring correct reading according to the size of the place, design of the place and the material of the elements in the place, as well as the material of the objects to be controlled, either by direct reading by zones or by capturing the power of the signal of each RFID tag, and using an algorithm to determine the position of objects.

Given that RFID technology is becoming common and that it is normal that the aircraft can have other RFID tags that are not to be considered by the computer associated with the aircraft, for example RFID tags attached to aircraft parts or provided by the manufacturer or by the aircraft maintenance units, or RFID tags on luggage or personal belongings of passengers, the database may contain information about standards of identification to be used as a protocol for considering RFID readings or for rejecting identifiers in the analysis process.

Although it was described that the system of the present invention may carry out the above referred operations, it may carry out other identification operations and generate further reports, such as inventories of items per category, etc.

In other embodiments of the system of the present invention, the external computer may be connected with the computers of a plurality of aircrafts, and the database of the computer may include information about each aircraft and provide reports about the items and persons onboard each aircraft.

In a preferred embodiment, the method for identifying and tracking items and persons inside vehicles of the present invention is used in one or more aircrafts having a plurality of items and persons that need to be monitored, wherein the method for identifying and tracking items and persons inside vehicles of the present invention comprising:

a) providing a database containing information such as: items that shall be onboard the aircraft during a specific time and date; persons that shall be onboard the aircraft during a specific time and date; authorized places inside the aircraft for the items that shall be onboard the aircraft; authorized places inside the aircraft for the persons that shall be onboard the aircraft; times and dates during which an item is authorized to be onboard the aircraft; times and dates during which a person is authorized to be onboard the aircraft; times and dates during which an item is authorized to be onboard the aircraft in specific places; times and dates during which a person is authorized to be onboard the aircraft in specific places;

b) detecting items and persons onboard the aircraft and obtain information about each item and person onboard the aircraft and location information about each item and person onboard the aircraft;

c) comparing the information about the item and persons obtained in the previous step and comparing said information with the database information and providing reports such as: inventory reports, report of persons onboard the aircraft, report of items that should not be onboard the aircraft during specific time and date, report of persons that should not be onboard the aircraft during specific time and date, reports about the location of each item/person inside the aircraft, reports about items/persons that are located in a place in which they are not authorized to be; report about the items/persons that have boarded the aircraft, in which time and dates, and the locations where they were inside the aircraft.

Finally it must be understood that the system and method for identifying and tracking items and persons inside vehicles of the present invention, is not limited exclusively to the embodiments above described and illustrated and that the persons having ordinary skill in the art can, with the teaching provided by the invention, to make modifications to the system and method for identifying and tracking items and persons inside vehicles of the present invention, which will clearly be within of the true inventive concept and of the scope of the invention which is claimed in the following claims.

What is claimed is:

1. A system for identifying and tracking items and persons inside a vehicle, each having a plurality of items and persons onboard, comprising:
one or more item identification means, each assigned to a respective item to be monitored inside a vehicle and containing information about an item;
one or more person identification means, each assigned to a respective person to be monitored inside the vehicle and containing information about a person;
one or more static identification means readers, each associated with the vehicle, for reading the one or more item identification means, and the one or more person identification means;
a computer associated with an aircraft is connected to the one or more identification means readers, said computer having a database containing information such as: items that shall be onboard the vehicle during a specific time and date;
persons that shall be onboard the vehicle during a specific time and date; authorized places inside the vehicle for the items that shall be onboard the vehicle; authorized places inside the vehicle for the persons that shall be onboard the vehicle; times and dates during which an item is authorized to be onboard the vehicle; times and dates during which a person is authorized to be onboard the vehicle; times and dates during which an item is authorized to be onboard the vehicle in specific places; times and dates during which a person is authorized to be onboard the vehicle in specific places;
wherein the computer provides reports such as: inventory reports, report of persons onboard the aircraft, report of items that should not be onboard the aircraft during specific time and date, report of persons that should not be onboard the aircraft during specific time and date, reports about the location of each item/person inside the aircraft, reports about items/persons that are located in a place in which they are not authorized to be; report about the items/persons that have boarded the aircraft, in which time and dates, and the locations where they were inside the aircraft.

2. A system for identifying and tracking items and persons inside a vehicle as claimed in claim 1, further including an external computer connected to the computer associated with an aircraft, by means of wireless communication or any other suitable communication means, and interchanging information with the computer associated with an vehicle, said external computer having a database containing information such as: items that shall be onboard the vehicle during a specific time and date; persons that shall be onboard the vehicle during a specific time and date; authorized places inside the vehicle for the items that shall be onboard the vehicle; authorized places inside the vehicle for the persons that shall be onboard the vehicle; times and dates during which an item is authorized to be onboard the vehicle; times and dates during which a person is authorized to be onboard the vehicle; times and dates during which an item is authorized to be onboard the vehicle in specific places; times and dates during which a person is authorized to be onboard the vehicle in specific places, and said external computer providing reports such as: inventory reports, report of persons onboard the vehicle, report of items that should not be onboard the vehicle during specific time and date, report of persons that should not be onboard the vehicle during specific time and date, reports about the location of each item/person inside the vehicle, reports about items/persons that are located in a place in which they are not authorized to be; report about the items/persons that have boarded the vehicle, in which time and dates, and the locations where they were inside the vehicle.

3. A system for identifying and tracking items and persons inside a vehicle as claimed in claim 1, further including an external computer connected to one or more computer associated with one or more vehicles, by means of wireless communication or any other suitable communication means, and interchanging information with the one or more computers associated with a vehicle, said external computer having a database containing information such as: items that shall be onboard each vehicle during a specific time and date; persons that shall be onboard each vehicle during a specific time and date; authorized places inside each vehicle for the items that shall be onboard each vehicle; authorized places inside each vehicle for the persons that shall be onboard each vehicle; times and dates during which an item is authorized to be onboard each vehicle; times and dates during which a person is authorized to be onboard each vehicle; times and dates during which an item is authorized to be onboard each vehicle in specific places; times and dates during which a person is authorized to be onboard each vehicle in specific places, and said external computer providing reports such as: inventory reports, report of persons onboard each vehicle, report of items that should not be onboard each vehicle during specific times and dates, report of persons that should not be onboard each vehicle during specific times and dates, reports about the location of each item/person inside each vehicle, reports about items/persons that are located in a place in which they are not authorized to be; report about the items/persons that have boarded each vehicle, in which time and dates, and the locations where they were inside each vehicle.

4. A system for identifying and tracking items and persons inside a vehicle as claimed in claim 1, wherein: the item identification means comprise RFID item identification tags; the person identification means comprise RFID person identification tags; and the identification means readers comprise RFID tag interrogators/scanners.

5. A method for identifying and tracking items and persons inside a vehicle having a plurality of items and persons onboard, comprising the steps of:
a) providing a database containing information such as: items that shall be onboard the vehicle during a specific time and date; persons that shall be onboard the vehicle during a specific time and date; authorized places inside the vehicle for the items that shall be onboard the vehicle; authorized places inside the vehicle for the persons that shall be onboard the vehicle; times and dates during which an item is authorized to be onboard the vehicle; times and dates during which a person is authorized to be onboard the vehicle; times and dates during which an item is authorized to be onboard the vehicle in specific places; times and dates during which a person is authorized to be onboard the vehicle in specific places;
b) detecting items and persons onboard the vehicle and obtain information about each item and person onboard the vehicle and location information about each item and person onboard the vehicle;
c) comparing the information about the items and persons obtained in the previous step and comparing said information with the database information and providing reports such as: inventory reports, report of persons onboard the vehicle, report of items that should not be onboard the vehicle during specific time and date, report of persons that should not be onboard the vehicle during specific time and date, reports about the location of each item/person inside the vehicle, reports about items/persons that are located in a place in which they are not authorized to be; report about the items/persons that have boarded the vehicle, in which time and dates, and the locations where they were inside the vehicle.

6. A method for identifying and tracking items and persons inside one or more vehicles, each having a plurality of items and persons onboard, comprising the steps of:
a) providing a database containing information such as: items that shall be onboard each vehicle during a specific time and date; persons that shall be onboard each vehicle during a specific time and date; authorized places inside each vehicle for the items that shall be onboard each vehicle; authorized places inside each vehicle for the persons that shall be onboard each vehicle; times and dates during which an item is authorized to be onboard each vehicle; times and dates during which a person is authorized to be onboard each vehicle; times and dates during which an item is authorized to be onboard each vehicle in specific places; times and dates during which a person is authorized to be onboard each vehicle in specific places;
b) detecting items and persons onboard each vehicle and obtain information about each item and person onboard each vehicle and location information about each item and person onboard each vehicle;
c) comparing the information about the items and persons obtained in the previous step and comparing said information with the database information and providing reports such as: inventory reports, report of persons onboard each vehicle, report of items that should not be onboard each vehicle during specific time and date, report of persons that should not be onboard each vehicle during specific times and dates, reports about the location of each item/person inside each vehicle, reports about items/persons that are located in a place in which they are not authorized to be; report about the items/persons that have boarded the vehicle, in which time and dates, and the locations where they were inside each vehicle.
